(19) United States
(12) Patent Application Publication
(10) Pub. No.: US 2024/0055654 A1
(43) Pub. Date: Feb. 15, 2024

(54) SOLID ELECTROLYTE MATERIAL AND BATTERY

(71) Applicant: Panasonic Intellectual Property Management Co., Ltd., Osaka (JP)

(72) Inventors: TOMOFUMI HAMAMURA, Kanagawa (JP); YOSHIMASA NAKAMA, Osaka (JP); YUI MASUMOTO, Osaka (JP)

(21) Appl. No.: 18/494,705

(22) Filed: Oct. 25, 2023

Related U.S. Application Data
(63) Continuation of application No. PCT/JP2022/013355, filed on Mar. 23, 2022.

(30) Foreign Application Priority Data
May 26, 2021 (JP) 2021-088783

(51) Int. Cl. H01M 10/0562; H01M 4/505; H01M 4/525; H01M 10/0525; C01F 17/36

(52) U.S. Cl. CPC H01M 10/0562; H01M 4/505; H01M 4/525; H01M 10/0525; C01F 17/36; H01M 2300/008; H01M 2004/028

(57) ABSTRACT

The solid electrolyte material contains a halide solid electrolyte. The halide solid electrolyte contains Li, at least one element selected from the group consisting of metalloids and metal elements other than Li, and at least one element selected from the group consisting of F, Cl, Br, and I. The halide solid electrolyte has a crystallite size greater than or equal to 40 nm.

### BACKGROUND

### 1. Technical Field

The present disclosure relates to a solid electrolyte material and a battery.

### 2. Description of the Related Art

In recent years, halogen-containing solid electrolyte materials have drawn much attention as the electrolyte material for batteries. Japanese Unexamined Patent Application Publication No. 2006-244734 discloses a battery that includes a solid electrolyte sandwiched between a positive electrode layer and a negative electrode layer, in which the solid electrolyte contains indium as a cation and a halogen as an anion.

### SUMMARY

In the related art, it is desirable to further improve the output properties of batteries that use halogen-containing solid electrolyte materials.

In one general aspect, the techniques disclosed here feature a solid electrolyte material containing a halide solid electrolyte, in which the halide solid electrolyte contains Li, at least one element selected from the group consisting of metalloids and metal elements other than Li, and at least one element selected from the group consisting of F, Cl, Br, and I, and the halide solid electrolyte has a crystallite size greater than or equal to 40 nm.

According to the present disclosure, the output properties of batteries that use halogen-containing solid electrolyte materials can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of a battery according to a second embodiment;

FIG. 2 is a diagram illustrating a method for producing the battery according to the second embodiment;

FIG. 3 is a schematic cross-sectional view illustrating the structure of a battery according to a third embodiment;

FIG. 4 is a graph indicating powder X-ray diffraction patterns of powder compacts of Example 1 and Comparative Example 1; and

FIG. 5 is a graph indicating the crystallinity of powder compacts of Examples 1 and 2 and Comparative Example 1.

### DETAILED DESCRIPTIONS

The inventors of the present disclosure have conducted extensive studies to improve the output properties of a battery that uses a halogen-containing solid electrolyte material. As a result, it has been found that the output properties of the battery are improved by adjusting the crystallite size of a halogen-containing solid electrolyte, in other words, a halide solid electrolyte, in a halogen-containing solid electrolyte material.

Hereinafter, the embodiments of the present disclosure are described with reference to the drawings.

### Summary of Aspects of the Present Disclosure

According to a first aspect of the present disclosure, there is provided a solid electrolyte material that includes:
a halide solid electrolyte,
in which the halide solid electrolyte contains Li, at least one element selected from the group consisting of metalloids and metal elements other than Li, and at least one element selected from the group consisting of F, Cl, Br, and I, and
the halide solid electrolyte has a crystallite size greater than or equal to 40 nm.

According to the first aspect, the battery output property improving effect is sufficiently exhibited since the solid electrolyte material contains a halide solid electrolyte that has high ion conductivity. Moreover, since the halide solid electrolyte has a crystallite size greater than or equal to 40 nm, the output properties of the battery are further improved.

According to a second aspect of the present disclosure, for example, in the solid electrolyte material of the first aspect, the halide solid electrolyte may be free of sulfur.

According to the second aspect, generation of hydrogen sulfide gas can be prevented. Thus, a battery with improved safety can be realized.

According to a third aspect of the present disclosure, for example, in the solid electrolyte material of the first or second aspect, the halide solid electrolyte may be represented by Formula (1) below:

Li_{α1}M1_{β1}X1_{γ1} (1)

where α1, β1, and γ1 are each a value greater than 0, M1 is at least one element selected from the group consisting of metalloids and metal elements other than Li, and X1 is at least one element selected from the group consisting of F, Cl, Br, and I.

According to the third aspect, the output properties of the battery can be further improved.

According to a fourth aspect of the present disclosure, for example, in the solid electrolyte material of the third aspect, in Formula (1), 2≤γ1/α1≤2.4 may be satisfied.

According to the fourth aspect, the output properties of the battery can be further improved.

According to a fifth aspect of the present disclosure, for example, in the solid electrolyte material of the third or fourth aspect, in Formula (1), 2.5≤α1≤3, 1≤β1≤1.1, and γ1=6 may be satisfied.

According to the fifth aspect, the output properties of the battery can be further improved.

According to a sixth aspect of the present disclosure, for example, in the solid electrolyte material of any one of third to fifth aspects, in Formula (1), M1 may include yttrium.

According to the sixth aspect, the output properties of the battery can be further improved.

According to a seventh aspect of the present disclosure, there is provided a battery that includes:
a positive electrode, an electrolyte layer, and a negative electrode arranged in this order,
in which at least one selected from the group consisting of the positive electrode, the electrolyte layer, and the negative electrode contains the solid electrolyte material of any one of the first to sixth aspects.

According to the seventh aspect, the output properties of the battery are further improved.

According to an eighth aspect of the present disclosure, for example, in the battery of the seventh aspect, the positive electrode may contain a positive electrode active material, and the positive electrode active material may contain lithium nickel cobalt manganese oxide.

According to the eighths aspect, the energy density of the battery can be further improved.

### First Embodiment

A solid electrolyte material according to a first embodiment contains a halide solid electrolyte. The halide solid electrolyte contains Li, at least one element selected from the group consisting of metalloids and metal elements other than Li, and at least one element selected from the group consisting of F, Cl, Br, and I. The halide solid electrolyte has a crystallite size greater than or equal to 40 nm.

According to these features, the battery output property improving effect is sufficiently exhibited since the solid electrolyte material contains a halide solid electrolyte that has high ion conductivity. Moreover, since the halide solid electrolyte has a crystallite size greater than or equal to 40 nm, the output properties of the battery are further improved. In the crystallites of the halide solid electrolyte of this embodiment, ion conduction proceeds smoothly. Meanwhile, at the crystallite interfaces of the halide solid electrolyte of this embodiment, the ion conductivity is low. By adjusting the crystallite size to be greater than or equal to 40 nm, the number of interfaces can be decreased. Thus, the ion conductivity can be improved.

In the present disclosure, the “metalloids” are B, Si, Ge, As, Sb, and Te. The “metal elements” are all group 1 to 12 elements other than hydrogen in the periodic table and all group 13 to 16 elements other than B, Si, Ge, As, Sb, Te, C, N, P, O, S, and Se in the periodic table. In other words, the “metalloids” and the “metal elements” are a group of elements that can form cations in forming an inorganic compound with a halogen.

The crystallite size of the halide solid electrolyte can be calculated by the following method. First, powder X-ray diffraction is performed on a halide solid electrolyte. The intensity of a particular X-ray diffraction peak in the obtained X-ray diffraction spectrum is used to calculate the crystallite size D (nm) of the halide solid electrolyte from Equations (I) and (II) below. For example, when the halide solid electrolyte is Li₃YBr₂Cl₄, the X-ray diffraction peak derived from the (002) plane of Li₃YBr₂Cl₄ is at 28.6°. In the present disclosure, the phrase “the halide solid electrolyte has a crystallite size greater than or equal to 40 nm” means that a halide solid electrolyte having a crystallite size greater than or equal to 40 nm can be sampled from at least one arbitrarily selected region of a member (for example, an electrolyte layer) of a battery.

D=Kλ/(B·cos θ) (I)

B=(B_{obs}²−b²)^{1/2} (II)

Equation (II) is the Scherrer's equation. In Equation (I), K represents a Scherrer constant. In this embodiment, K is 0.94. λ represents the wavelength of the X-ray source. In this embodiment, the X-ray source is CuKα radiation, and λ is 0.15406 nm. θ represents the Bragg angle. In Equation (II), B_{obs} represents a full width at half maximum of the particular peak in the X-ray diffraction spectrum of the halide solid electrolyte. Here, b represents the full width at half maximum of a standard sample. A standard Si powder (SRM640 series) distributed by National Institute of Standards and Technology (NIST) in US is used as the standard sample. The full width at half maximum is a full width at half maximum of an X-ray diffraction peak derived from the Si(111) plane (2θ=approximately 28.4°).

The halide solid electrolyte may have a crystallite size greater than or equal to 45 nm, greater than or equal to 60 nm, or greater than or equal to 75 nm.

The upper limit of the crystallite size of the halide solid electrolyte is not particularly limited. The halide solid electrolyte may have, for example, a crystallite size less than or equal to 250 nm, less than or equal to 200 nm, or less than or equal to 150 nm.

The halide solid electrolyte may be free of sulfur. According to this feature, generation of hydrogen sulfide gas can be prevented. Thus, a battery with improved safety can be realized.

The halide solid electrolyte may be represented by Formula (1) below:

Li_{α1}M1_{β1}X1_{γ1} (1)

Here, α1, β1, and γ1 are each a value greater than θ. M1 is at least one element selected from the group consisting of metalloids and metal elements other than Li. X1 is at least one element selected from the group consisting of F, Cl, Br, and I. According to this feature, the ion conductivity of the solid electrolyte material can be improved. Thus, the output properties of the batteries can be further improved.

In Formula (1), 2≤γ1/α1≤2.4 may be satisfied. According to this feature, the ion conductivity of the solid electrolyte material can be further improved. Thus, the output properties of the battery can be further improved.

In Formula (1), 2.5≤α1≤3, 1≤β1≤1.1, and γ1=6 may be satisfied. According to this feature, the ion conductivity of the solid electrolyte material can be further improved. Thus, the output properties of the battery can be further improved.

In Formula (1), M1 may include yttrium (Y). In other words, the halide solid electrolyte may contain Y as a metal element. According to this feature, the ion conductivity of the solid electrolyte material can be further improved. Thus, the output properties of the battery can be further improved.

The Y-containing halide solid electrolyte may be a compound represented by the formula LiₐMe_{b}Y_{c}X1₆, for example. Here, a+mb+3c=6, and c>0 are satisfied. Me is at least one element selected from the group consisting of metalloids and metal elements other than Li and Y. m represents the valency of Me. X1 is at least one element selected from the group consisting of F, Cl, Br, and I. According to these features, the ion conductivity of the solid electrolyte material can be further improved. Thus, the output properties of the battery can be further improved.

Me may be at least one element selected from the group consisting of Mg, Ca, Sr, Ba, Zn, Sc, Al, Ga, Bi, Zr, Hf, Ti, Sn, Ta, and Nb, for example. According to these features, the ion conductivity of the solid electrolyte material can be further improved. Thus, the output properties of the battery can be further improved.

Examples of the halide solid electrolyte are the following materials. According to the feature described below, the ion conductivity of the solid electrolyte material can be further improved. Thus, the output properties of the battery can be further improved.

The halide solid electrolyte may be a material represented by Formula (A1) below.

Li_{6-3d}Y_{d}X1₆ (A1)

In Formula (A1), X1 is at least one element selected from the group consisting of F, Cl, Br, and I.

In Formula (A1), 0<d<2 is satisfied.

The halide solid electrolyte may be a material represented by Formula (A2) below.

Li₃YX1₆ (A2)

In Formula (A2), X1 is at least one element selected from the group consisting of F, Cl, Br, and I.

The halide solid electrolyte may be a material represented by Formula (A3) below.

Li_{3-3δ}Y_{1+δ}Cl₆ (A3)

In Formula (A3), 0<δ≤0.15 is satisfied.

The halide solid electrolyte may be a material represented by Formula (A4) below.

Li_{3-3δ}Y_{1+δ}Br₆ (A4)

In Formula (A4), 0<δ≤0.25 is satisfied.

The halide solid electrolyte may be a material represented by Formula (A5) below.

Li_{3-3δ+a}Y_{1+δ-a}MeₐCl₆₋ₓBrₓ (A5)

In Formula (A5), Me is at least one element selected from the group consisting of Mg, Ca, Sr, Ba, and Zn.

In Formula (A5), −1<δ<2, 0<a<3, 0<(3−3δ+a), 0<(1+δ −a), and 0≤x≤6 are satisfied.

The halide solid electrolyte may be a material represented by Formula (A6) below.

Li_{3-3δ}Y_{1+δ-a}MeₐCl₆₋ₓBrₓ (A6)

In Formula (A6), Me is at least one element selected from the group consisting of Al, Sc, Ga, and Bi.

In Formula (A6), −1<δ<1, 0<a<2, 0<(1+δ −a), and 0≤x≤6 are satisfied.

The halide solid electrolyte may be a material represented by Formula (A7) below.

Li_{3-3δ-a}Y₁₊δ₋ₐMeₐCl₆₋ₓBrₓ (A7)

In Formula (A7), Me is at least one element selected from the group consisting of Zr, Hf, and Ti.

In Formula (A7), −1<δ<1, 0<a<1.5, 0<(3−3δ−a), 0<(1+δ −a), and 0≤x≤6 are satisfied.

The halide solid electrolyte may be a material represented by Formula (A8) below.

Li_{3-3δ-2a}Y_{1+δ-a}MeₐCl₆₋ₓBrₓ (A8)

In Formula (A8), Me is at least one element selected from the group consisting of Ta and Nb.

In Formula (A8), −1<δ<1, 0<a<1.2, 0<(3−3δ−2a), 0<(1+δ −a), and 0≤x≤6 are satisfied.

Specific examples of the halide solid electrolyte that can be used include Li₃YX1₆, Li₂MgX1₄, Li₂FeX1₄, Li(Al,Ga,In)X1₄, and Li₃(Al,Ga,In)X1₆. Here, X1 is at least one element selected from the group consisting of F, Cl, Br, and I.

In the present disclosure, the notation “(Al,Ga,In)” means at least one element selected from the group of elements in the parentheses. In other words, “(Al,Ga,In)” has the same meaning as the “at least one selected from the group consisting of Al, Ga, and In”. The same applies to other elements.

### Second Embodiment

A second embodiment will now be described. The descriptions that overlap those of the first embodiment are omitted as appropriate.

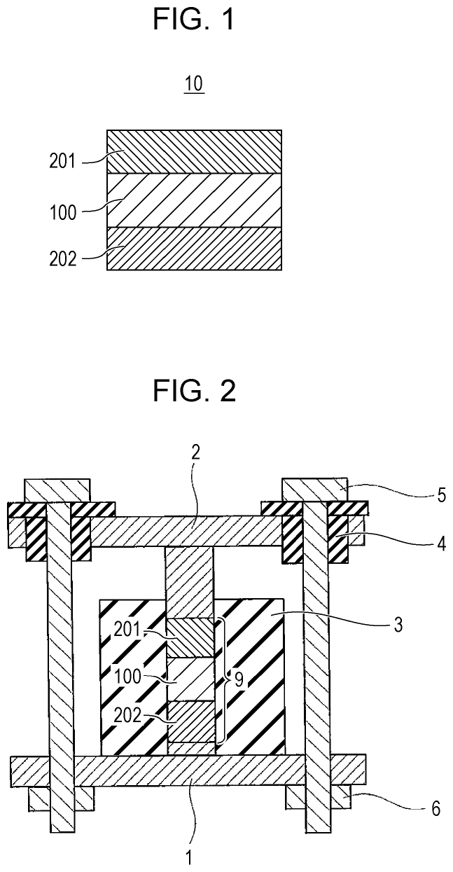

FIG. 1 is a schematic cross-sectional view illustrating the structure of a battery 10 according to a second embodiment.

The battery 10 includes a positive electrode 201, an electrolyte layer 100, and a negative electrode 202 arranged in this order. The positive electrode 201, the electrolyte layer 100, and the negative electrode 202 are stacked in this order. The electrolyte layer 100 is disposed between the positive electrode 201 and the negative electrode 202. At least one selected from the group consisting of the positive electrode 201, the electrolyte layer 100, and the negative electrode 202 contains a solid electrolyte material according to the first embodiment. That is, the solid electrolyte material contains a halide solid electrolyte. The halide solid electrolyte contains Li, at least one element selected from the group consisting of metalloids and metal elements other than Li, and at least one element selected from the group consisting of F, Cl, Br, and I. The halide solid electrolyte has a crystallite size greater than or equal to 40 nm.

According to these features, the battery 10 output property improving effect is sufficiently exhibited due to the halide solid electrolyte that has high ion conductivity. Moreover, since the halide solid electrolyte has a crystallite size greater than or equal to 40 nm, the output properties of the battery 10 are further improved. In the crystallites of the halide solid electrolyte of this embodiment, ion conduction proceeds smoothly. Meanwhile, at the crystallite interfaces of the halide solid electrolyte of this embodiment, the ion conductivity is low. By adjusting the crystallite size to be greater than or equal to 40 nm, the number of interfaces can be decreased, and thus the ion conductivity can be improved.

According to the aforementioned mechanism, the desired effect is obtained as long as the halide solid electrolyte having a crystallite size greater than or equal to 40 nm is contained in any one of the positive electrode 201, the electrolyte layer 100, and the negative electrode 202.

The halide solid electrolyte having a crystallite size greater than or equal to 40 nm may be contained in two selected from or one selected from the group consisting of the positive electrode 201, the electrolyte layer 100, and the negative electrode 202, or may be contained in all of these.

In this embodiment, the electrolyte layer 100 is in contact with the positive electrode 201 and the negative electrode 202.

The average thickness of the electrolyte layer 100 may be greater than or equal to 1 μm and less than or equal to 300 μm. When the electrolyte layer 100 has an average thickness greater than or equal to 1 μm, short circuiting between the positive electrode 201 and the negative electrode 202 rarely occurs. When the average thickness of the electrolyte layer 100 is less than or equal to 300 μm, the battery 10 can operate at high output.

The average thickness of the electrolyte layer 100 can be measured by the following method. A cross section of the electrolyte layer 100 is observed with a scanning electron microscope (SEM). The cross section is a section taken parallel in a direction in which the layers are stacked, and includes the center of gravity of the electrolyte layer 100 in a plan view. In the obtained cross-sectional SEM image, three points are selected arbitrarily. The thickness of the electrolyte layer is measured at the arbitrarily selected three points. The average of the measured values is deemed to be the average thickness.

The electrolyte layer 100 may contain a solid electrolyte material that contains the aforementioned halide solid electrolyte. When the electrolyte layer 100 contains a halide solid electrolyte, the output properties of the battery 10 are further improved.

The electrolyte layer 100 may contain 100 mass % of a halide solid electrolyte in terms of the mass ratio relative to the entirety of the electrolyte layer 100 excluding the unavoidable impurities. In other words, the electrolyte layer 100 may consist essentially of a halide solid electrolyte.

The electrolyte layer 100 may contain a halide solid electrolyte as a main component and, additionally, may contain unavoidable impurities or starting materials used for the synthesis of the halide solid electrolyte, by-products, and decomposition products. The ratio of the mass of the halide solid electrolyte relative to the mass of the electrolyte layer 100 may be, for example, greater than or equal to 50 mass % or greater than or equal to 70 mass %.

The positive electrode 201 contains, as a positive electrode active material, for example, a material that has properties of occluding and releasing metal ions (for example, lithium ions). Examples of the positive electrode active material that can be used include lithium-containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(Ni,Co,Al)O₂, Li(Ni,Co,Mn)O₂, and LiCoO₂. In particular, when a lithium-containing transition metal oxide is used as the positive electrode active material, the production cost can be reduced, and the average discharge voltage can be increased.

The positive electrode active material may contain lithium nickel cobalt manganese oxide. For example, the positive electrode active material may contain Li(Ni,Co,Mn)O₂. According to this feature, the energy density of the battery 10 can be further improved. The positive electrode active material may be Li(Ni,Co,Mn)O₂.

The positive electrode 201 may contain an electrolyte material, for example, a solid electrolyte material. The solid electrolyte material contained in the positive electrode 201 may contain a halide solid electrolyte. The halide solid electrolytes described as examples in the first embodiment can be used as the halide solid electrolyte contained in the positive electrode 201. According to this feature, the output properties of the battery 10 can be further improved.

Examples of the solid electrolyte contained in the positive electrode 201 other than the halide solid electrolytes described as examples in the first embodiment include sulfide solid electrolytes, oxide solid electrolytes, polymeric solid electrolytes, and complex hydride solid electrolytes. According to this feature also, the output properties of the battery 10 can be further improved.

Examples of the sulfide solid electrolytes include Li₂S—P₂S₅, Li₂S—SiS₂, Li₂SB₂S₃, Li₂S—GeS₂, Li_{3.25}Ge_{0.25}P_{0.75}S₄, and Li₁₀GeP₂Si₂. To these, LiX, Li₂O, MO_{q}, LiₚMO_{q}, or the like may be added. Here, X is at least one element selected from the group consisting of F, Cl, Br, and I. M is at least one element selected from the group consisting of P, Si, Ge, B, Al, Ga, In, Fe, and Zn. p and q each represent a natural number. At least one sulfide solid electrolyte selected from the aforementioned materials can be used.

Examples of the oxide solid electrolyte include NASICON solid electrolytes such as LiTi₂(PO₄)₃ and element substitution products thereof, perovskite solid electrolytes based on (LaLi)TiO₃, LISICON solid electrolytes such as Li₁₄ZnGe₄O₁₆, Li₄SiO₄, LiGeO₄, and element substitution products thereof, garnet solid electrolytes such as Li₇La₃Zr₂O₁₂ and element substitution products thereof, Li₃PO₄ and N substitution products thereof, and glass or glass ceramic based on a Li—B—O compound such as LiBO₂ or Li₃BO₃ doped with Li₂SO₄, Li₂CO₃, or the like. At least one oxide sulfide solid electrolyte selected from the aforementioned materials can be used.

The polymeric solid electrolyte can be, for example, a compound between a polymer compound and a lithium salt. The polymer compound may have an ethylene oxide structure. The polymer compound having an ethylene oxide structure can contain a large amount of lithium salts. Thus, the ion conductivity can be further increased. Examples of the lithium salt that can be used include LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), and LiC(SO₂CF₃)₃. One lithium salt may be used alone, or a combination of two or more lithium salts may be used.

Examples of the complex hydride solid electrolyte that can be used include LiBH₄—LiI and LiBH₄—P₂S₅.

The shape of the solid electrolyte contained in the battery 10 is not particularly limited. The shape of the solid electrolyte may be, for example, a needle shape, a spherical shape, or an oval shape. For example, the solid electrolyte may have a particle shape.

When the solid electrolyte contained in the positive electrode 201 has a particle shape (for example, a spherical shape), the median diameter of the solid electrolyte contained in the positive electrode 201 may be less than or equal to 100 μm. When the median diameter of the solid electrolyte is less than or equal to 100 μm, the positive electrode active material and the solid electrolyte can form an excellent dispersion state in the positive electrode 201. As a result, the charge-discharge characteristics of the battery 10 are improved.

When the solid electrolyte contained in the positive electrode 201 has a particle shape (for example, a spherical shape), the median diameter of the solid electrolyte contained in the positive electrode 201 may be less than or equal to 10 μm. When the median diameter of the solid electrolyte is less than or equal to 10 μm, the positive electrode active material and the solid electrolyte can form a better dispersion state in the positive electrode 201.

The median diameter of the solid electrolyte contained in the positive electrode 201 may be smaller than the median diameter of the positive electrode active material. In this manner, the positive electrode active material and the solid electrolyte can form an excellent dispersion state in the positive electrode 201.

The median diameter of the positive electrode active material may be greater than or equal to 0.1 μm and less than or equal to 100 μm. When the median diameter of the positive electrode active material is greater than or equal to 0.1 μm, the positive electrode active material and the solid electrolyte can form an excellent dispersion state in the positive electrode 201. Thus, the charge-discharge characteristics of the battery 10 are improved. When the median diameter of the positive electrode active material is less than or equal to 100 μm, lithium diffuses faster in the positive electrode active material. Thus, the battery 10 can operate at high output.

In the present description, the median diameters of the positive electrode active material and the solid electrolyte are the particle diameters (d50) at an accumulation volume of 50% in the particle size distribution measured by a laser diffraction scattering method on a volume basis. The particle size distribution can be measured by, for example, using an image analyzer. The same applies to other materials.

The volume ratio “v1:100−v1” of the positive electrode active material to the solid electrolyte contained in the positive electrode 201 may satisfy 30≤v1≤95. Here, v1 represents the volume ratio of the positive electrode active material with respect to a total volume of 100 of the positive electrode active material and the solid electrolyte contained in the positive electrode 201. When 30≤v1, a sufficient battery energy density can be secured. When v1≤95, the battery 10 can operate at high output.

The average thickness of the positive electrode 201 may be greater than or equal to 10 μm and less than or equal to 500 μm. When the average thickness of the positive electrode 201 is greater than or equal to 10 μm, a sufficient battery energy density can be secured. When the average thickness of the positive electrode 201 is less than or equal to 500 μm, the battery 10 can operate at high output.

The method for measuring the average thickness of the electrolyte layer 100 described above can be applied to the method for measuring the average thickness of the positive electrode 201. The same method can be applied to measuring the average thickness of the negative electrode 202.

The negative electrode 202 contains, as a negative electrode active material, for example, a material that has properties of occluding and releasing metal ions (for example, lithium ions). Examples of the negative electrode active material that can be used include metal materials, carbon materials, oxides, nitrides, tin compounds, and silicon compounds. The metal material may be a single metal. The metal material may be an alloy. Examples of the metal material include lithium metal and lithium alloys. Examples of the carbon materials include natural graphite, coke, graphitizing carbon, carbon fibers, spherical carbon, synthetic graphite, and amorphous carbon. The capacity density can be improved by using silicon (Si), tin (Sn), a silicon compound, a tin compound, etc. Examples of the oxide include Li₄Ti₅O₁₂, LiTi₂O₄, and TiO₂.

The negative electrode 202 may contain an electrolyte material, for example, a solid electrolyte material. The solid electrolyte material contained in the negative electrode 202 may contain a halide solid electrolyte. The halide solid electrolytes described as examples in the first embodiment can be used as the halide solid electrolyte contained in the negative electrode 202. According to this feature, the output properties of the battery 10 can be further improved.

When the solid electrolyte contained in the negative electrode 202 has a particle shape (for example, a spherical shape), the median diameter of the solid electrolyte contained in the negative electrode 202 may be less than or equal to 100 μm. When the median diameter of the solid electrolyte is less than or equal to 100 μm, the negative electrode active material and the solid electrolyte can form an excellent dispersion state in the negative electrode 202. As a result, the charge-discharge characteristics of the battery 10 are improved.

When the solid electrolyte contained in the negative electrode 202 has a particle shape (for example, a spherical shape), the median diameter of the solid electrolyte contained in the negative electrode 202 may be less than or equal to 10 μm. When the median diameter of the solid electrolyte is less than or equal to 10 μm, the negative electrode active material and the solid electrolyte can form a better dispersion state in the negative electrode 202.

The median diameter of the solid electrolyte contained in the negative electrode 202 may be smaller than the median diameter of the negative electrode active material. In this manner, the negative electrode active material and the solid electrolyte can form an excellent dispersion state in the negative electrode 202.

The median diameter of the negative electrode active material may be greater than or equal to 0.1 μm and less than or equal to 100 μm. When the median diameter of the negative electrode active material is greater than or equal to 0.1 μm, the negative electrode active material and the solid electrolyte can form an excellent dispersion state in the negative electrode 202. As a result, the charge-discharge characteristics of the battery 10 are improved. When the median diameter of the negative electrode active material is less than or equal to 100 μm, lithium diffuses faster in the negative electrode active material. Thus, the battery 10 can operate at high output.

The volume ratio “v2:100−v2” of the negative electrode active material to the solid electrolyte contained in the negative electrode 202 may satisfy 30≤v2≤95. Here, v2 represents the volume ratio of the negative electrode active material with respect to a total volume of 100 of the negative electrode active material and the solid electrolyte contained in the negative electrode 202. When 30≤v2, a sufficient battery energy density can be secured. When v2≤95, the battery 10 can operate at high output.

The average thickness of the negative electrode 202 may be greater than or equal to 10 μm and less than or equal to 500 μm. When the average thickness of the negative electrode 202 is greater than or equal to 10 μm, a sufficient battery energy density can be secured. When the average thickness of the negative electrode 202 is less than or equal to 500 μm, the battery 10 can operate at high output.

The positive electrode active material and the negative electrode active material may be coated with a coating material in order to decrease the interfacial resistance between each of the active materials and the solid electrolyte. A material having a low electronic conductivity can be used as the coating material. Examples of the coating material that can be used include sulfide solid electrolytes, oxide solid electrolytes, halide solid electrolytes, polymeric solid electrolytes, and complex hydride solid electrolytes.

The coating material may be an oxide solid electrolyte.

Examples of the oxide solid electrolyte that can be used as the coating material include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li—V—O compounds such as LiV₂O₅, and Li—W—O compounds such as Li₂WO₄. The oxide solid electrolyte has high ion conductivity. The oxide solid electrolyte has excellent high-potential stability. Thus, by using an oxide solid electrolyte as a coating material, the charge-discharge efficiency of the battery 10 can be further improved.

The electrolyte layer 100 may contain at least one electrolyte selected from the group consisting of sulfide solid electrolytes, oxide solid electrolytes, polymeric solid electrolytes, and complex hydride solid electrolytes. Examples of the sulfide solid electrolytes, the oxide solid electrolytes, the polymeric solid electrolytes, and the complex hydride solid electrolytes are the same as those materials described as examples of the solid electrolyte contained in the positive electrode 201. According to this feature, lithium ion exchange is facilitated. As a result, the output properties of the battery 10 can be further improved.

At least one selected from the group consisting of the positive electrode 201, the electrolyte layer 100, and the negative electrode 202 may contain a nonaqueous electrolyte solution, a gel electrolyte, or an ionic liquid. According to this feature, lithium ion exchange is facilitated. As a result, the output properties of the battery 10 can be further improved.

The nonaqueous electrolyte solution contains a nonaqueous solvent and a lithium salt dissolved in the nonaqueous solvent. Examples of the nonaqueous solvent that can be used include cyclic carbonate solvents, linear carbonate solvents, cyclic ether solvents, linear ether solvents, cyclic ester solvents, linear ester solvents, and fluorine solvents. Examples of the cyclic carbonate solvents include ethylene carbonate, propylene carbonate, and butylene carbonate. Examples of the linear carbonate solvents include dimethyl carbonate, ethyl methyl carbonate, and diethyl carbonate. Examples of the cyclic ether solvents include tetrahydrofuran, 1,4-dioxane, and 1,3-dioxolane. Examples of the linear ether solvents include 1,2-dimethoxyethane and 1,2-diethoxyethane. An example of the cyclic ester solvents is γ-butyrolactone. An example of the linear ester solvents is methyl acetate. Examples of the fluorine solvents include fluoroethylene carbonate, methyl fluoropropionate, fluorobenzene, fluoroethyl methyl carbonate, and fluorodimethylene carbonate. One nonaqueous solvent selected from these may be used alone, or a mixture of two or more nonaqueous solvents selected from these may be used.

The nonaqueous electrolyte solution may contain at least one fluorine solvent selected from the group consisting of fluoroethylene carbonate, methyl fluoropropionate, fluorobenzene, fluoroethyl methyl carbonate, and fluorodimethylene carbonate.

Examples of the lithium salt that can be used include LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used alone as the lithium salt, or a mixture of two or more lithium salts selected from these may be used as the lithium salt. The lithium salt concentration is, for example, greater than or equal to 0.5 mol/L and less than or equal to 2 mol/L.

A polymer material impregnated with a nonaqueous electrolyte solution can be used as the gel electrolyte. Examples of the polymer material that can be used include polyethylene oxide, polyacrylonitrile, polyvinylidene fluoride, polymethyl methacrylate, and polymers having ethylene oxide bonds.

Examples of the cations constituting the ionic liquid include aliphatic linear quaternary salts such as tetraalkylammonium and tetraalkylphosphonium, aliphatic cyclic ammoniums such as pyrrolidiniums, morpholiniums, imidazoliniums, tetrahydropyrimidiniums, piperaziniums, and piperidiniums, and nitrogen-containing heterocyclic aromatic cations such as pyridiniums and imidazoliums. The anions constituting the ionic liquid may be PF₆⁻, BF₄⁻, SbF⁻, AsF₆⁻, SO₃CF₃⁻, N(SO₂F)₂⁻, N(SO₂CF₃)₂⁻, N(SO₂C₂F₅)₂⁻, N(SO₂CF₃)(SO₂C₄F₉)⁻, C(SO₂CF₃)₃⁻, or the like. The ionic liquid may contain a lithium salt.

At least one selected from the group consisting of the positive electrode 201, the electrolyte layer 100, and the negative electrode 202 may contain a binder to improve adhesion between particles. The binder is used to improve the binding property of the material constituting the electrode. Examples of the binder include polyvinylidene fluoride, polytetrafluoroethylene, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene-butadiene rubber, and carboxymethylcellulose. A copolymer of two or materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can also be used as the binder. A mixture of two or more selected from among the aforementioned materials may be used as the binder.

At least one selected from the positive electrode 201 and the negative electrode 202 may contain a conductive additive to increase electron conductivity. Examples of the conductive additive that can be used include graphites such as natural and synthetic graphite, carbon blacks such as acetylene black and Ketjen black, conductive fibers such as carbon fibers and metal fibers, fluorinated carbon, metal powders such as aluminum, conductive whiskers such as zinc oxide and potassium titanate, conductive metal oxides such as titanium oxide, and conductive polymer compounds such as polyaniline, polypyrrole, and polythiophene. When a carbon conductive additive is used as the conductive additive, the cost can be reduced.

Examples of the shape of the battery 10 include a coin shape, a cylinder shape, a prism shape, a sheet shape, a button shape, a flat shape, and a multilayer shape.

The battery 10 that includes the positive electrode 201, the electrolyte layer 100, and the negative electrode 202 may be stacked in multiple layers with current collectors therebetween. Connecting more than one batteries electrically in series can increase the voltage of the battery. Connecting more than one batteries electrically in parallel can increase the capacity of the battery. Connecting more than one batteries electrically in series and in parallel can increase the voltage and the capacity of the battery.

### Method for Producing Solid Electrolyte Material

In this embodiment, a halide solid electrolyte represented by Formula (1) serving as a solid electrolyte material can be produced by, for example, the following method.

First, in accordance with the target composition, multiple types of raw material powders of a binary halide are prepared. A binary halide refers to a compound constituted by two elements including a halogen. For example, when Li₃YCl₆ is to be prepared, the raw material powders LiCl and YCl₃ are prepared at a molar ratio of 3:1. Here, the elements represented by “M1” and “X1” in Formula (1) are determined by selecting the type of the raw material powder. Moreover, the values represented by “α1”, “β1”, and “γ1” in Formula (1) are determined by adjusting the type of the raw material powder, the blend ratio of the raw material powders, and the synthetic process.

After the raw material powders are mixed and crushed, the raw material powders are reacted with one another by mechanochemical milling. Alternatively, after mixing and crushing the raw material powders, the resulting mixture may be sintered in vacuum or in an inert atmosphere. For example, heat treatment may be performed in the temperature range of 100° C. to 400° C. for 1 hour or longer. A halide solid electrolyte represented by Formula (1) is obtained by such methods.

### Method for Producing Battery

A battery 10 that uses, as a solid electrolyte material, the halide solid electrolyte produced as mentioned above can be produced by, for example, the following method (dry method).

FIG. 2 is a diagram illustrating a method for producing the battery 10. As illustrated in FIG. 2, a lower die 1 is inserted into an insulating tube 3. A powder of a solid electrolyte material is placed in the insulating tube 3. An upper die 2 is inserted into the insulating tube 3, and the powder of the solid electrolyte material is pressed to form an electrolyte layer 100. The upper die 2 is removed, and a powder of a positive electrode material is placed in the insulating tube 3. The upper die 2 is inserted into the insulating tube 3 again, and the powder of the positive electrode material is pressed to form a positive electrode 201 on the electrolyte layer 100. The positive electrode material may contain a halide solid electrolyte.

After formation of the positive electrode 201, the lower die 1 is removed, and a powder of a negative electrode material is placed in the insulating tube 3. The lower die 1 is inserted again, and the powder of the negative electrode material is pressed to form a negative electrode 202. As a result, a power generating element 9 is formed. The negative electrode material may contain a halide solid electrolyte.

Next, press-forming is performed at a temperature higher than or equal to 100° C. As a result, a multilayer body that includes a positive electrode 201, an electrolyte layer 100, and a negative electrode 202 is obtained. The press-forming is preferably performed at a temperature of 120° C. The temperature of press-forming refers to a surface temperature of the dies used for pressing.

In the example described above, after all of the positive electrode 201, the electrolyte layer 100, and the negative electrode 202 are stacked, the stack is pressed while being heated at a temperature higher than or equal to 100° C. However, the timing of pressing under heating is not limited to this. For example, in forming the electrolyte layer 100, the powder of a solid electrolyte material may be pressed while being heated. In forming the positive electrode 201, the powder of a positive electrode material may be pressed while being heated. In forming the negative electrode 202, the powder of a negative electrode material may be pressed while being heated. Each of the electrolyte layer 100, the positive electrode 201, and the negative electrode 202 may be pressed while being heated, and then the positive electrode 201, the electrolyte layer 100, and the negative electrode 202 may be stacked and then further pressed while being heated.

Stainless steel current collectors are placed at the bottom and on the top of the multilayer body, and current collecting leads are attached to the current collectors. Lastly, the inside of the insulating tube 3 is shut-out from the outside atmosphere and sealed by using an insulating ferrule. The lower die 1 and the upper die 2 are fixed with an insulating tube 4, a bolt 5, and a nut 6. As a result, a battery 10 is obtained.

The battery 10 is equipped with a positive electrode 201, an electrolyte layer 100, and a negative electrode 202 obtained by press-forming at a temperature higher than or equal to 100° C. According to these features, the crystallite size can be adjusted so that the halide solid electrolyte has a crystallite size greater than or equal to 40 nm. As a result, a battery 10 having particularly improved output properties can be realized.

The battery 10 that uses, as a solid electrolyte material, the halide solid electrolyte produced as mentioned above can also be produced by a wet method. In the wet method, for example, a positive electrode slurry that contains a positive electrode active material and a solid electrolyte is applied to a current collector to form a coating film. Next, the coating film is passed through rolls or a flat plate press heated to a temperature higher than or equal to 120° C. to be pressed. As a result, a positive electrode 201 is obtained. The electrolyte layer 100 and the negative electrode 202 are prepared in the same manner. Next, the positive electrode 201, the electrolyte layer 100, and the negative electrode 202 are stacked in this order, and then press-formed at a temperature higher than or equal to 100° C. As a result, the crystallite size can be adjusted so that the halide solid electrolyte has a crystallite size greater than or equal to 40 nm.

### Third Embodiment

A third embodiment will now be described. The descriptions that overlap those of the first and second embodiments are omitted as appropriate.

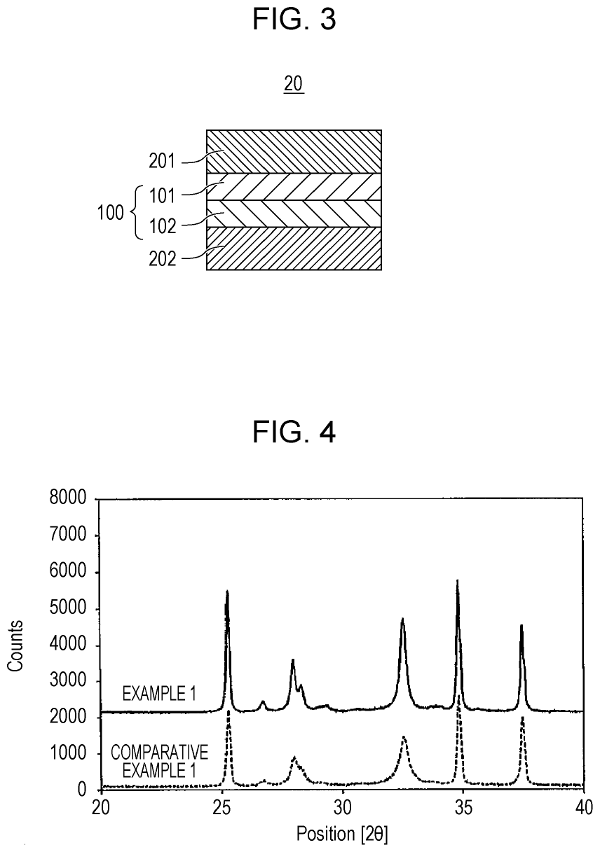

FIG. 3 is a schematic cross-sectional view illustrating the structure of a battery 20 according to a third embodiment.

The battery 20 includes a positive electrode 201, a first electrolyte layer 101, a second electrolyte layer 102, and a negative electrode 202 arranged in this order. The positive electrode 201, the first electrolyte layer 101, the second electrolyte layer 102, and the negative electrode 202 are stacked in this order. The electrolyte layer 100 includes the first electrolyte layer 101 and the second electrolyte layer 102. The electrolyte layer 100 is disposed between the positive electrode 201 and the negative electrode 202. The first electrolyte layer 101 contains a first solid electrolyte material. The second electrolyte layer 102 contains a second solid electrolyte material. The first solid electrolyte material and the second solid electrolyte material contain halide solid electrolytes. The halide solid electrolyte contained in the first solid electrolyte material has a composition different from the composition of the halide solid electrolyte contained in the second solid electrolyte material. At least one selected from the group consisting of the halide solid electrolyte contained in the first solid electrolyte material and the halide solid electrolyte contained in the second solid electrolyte material has a crystallite size greater than or equal to 40 nm. Examples of the halide solid electrolytes contained in the first solid electrolyte material and the second solid electrolyte material are the halide solid electrolytes described as examples in the first embodiment.

According to these features also, the battery 20 output property improving effect is sufficiently exhibited due to the halide solid electrolytes that have high ion conductivity. In addition, the output properties of the battery 20 are further improved since at least one selected from the group consisting of the halide solid electrolyte contained in the first solid electrolyte material and the halide solid electrolyte contained in the second solid electrolyte material has a crystallite size greater than or equal to 40 nm.

Both of the halide solid electrolyte contained in the first solid electrolyte material and the halide solid electrolyte contained in the second solid electrolyte material may have a crystallite size greater than or equal to 40 nm. One of the halide solid electrolyte contained in the first solid electrolyte material and the halide solid electrolyte contained in the second solid electrolyte material may have a crystallite size greater than or equal to 40 nm.

When the halide solid electrolyte contained in the second solid electrolyte material contains iodine (I), the halide solid electrolyte contained in the first solid electrolyte material may be free of iodine. When iodine is contained as a halogen in a solid electrolyte, oxidation reaction of iodine during charging forms an oxidative decomposition layer having poor lithium ion conductivity between the positive electrode active material and the solid electrolyte. This oxidative decomposition layer functions as a large interfacial resistance in the electrode reaction at the positive electrode. However, according to the aforementioned features, the positive electrode 201 is separated from the I-containing second electrolyte layer 102 by the first electrolyte layer 101, and thus direct contact is avoided. Thus, the oxidative decomposition layer is rarely formed during charging. As a result, a battery 20 having further improved output properties can be realized.

The halide solid electrolytes contained in the first solid electrolyte material and the second solid electrolyte material may be free of sulfur. According to this feature, generation of hydrogen sulfide gas can be prevented

In this embodiment, the electrolyte layer 100 is in contact with the positive electrode 201 and the negative electrode 202. Specifically, the first electrolyte layer 101 is in contact with the positive electrode 201. The second electrolyte layer 102 is in contact with the negative electrode 202. The first electrolyte layer 101 is in contact with the second electrolyte layer 102.

The second electrolyte layer 102 does not have to be in contact with the positive electrode 201. A solid electrolyte that contains iodine as a halogen has excellent ion conductivity but has poor oxidation stability. Thus, according to this feature, even when the second electrolyte layer 102 contains an iodine-containing halide solid electrolyte, the oxidative decomposition layer is rarely formed during charging. Thus, the output properties of the battery 20 can be further improved.

The halide solid electrolyte contained in the second solid electrolyte material may be represented by Formula (2) below:

Li_{α2}M2_{β2}X2_{γ2} (2)

Here, α2, β2, and γ2 are each a value greater than 0. M2 contains at least one element selected from the group consisting of metalloids and metal elements other than Li. X2 contains I and at least one element selected from the group consisting of F, Cl, and Br. The I-containing halide solid electrolyte has higher ion conductivity than halide solid electrolytes free of I. Thus, according to these features, the ion conductivity of the second solid electrolyte material can be improved. As a result, the output properties of the battery 20 can be further improved.

In Formula (2), 2.7≤α2≤3, 1≤β2≤1.1, and γ2=6 may be satisfied. According to this feature, the ion conductivity of the second solid electrolyte material can be further improved. As a result, the output properties of the battery 20 can be further improved.

In Formula (2), M2 may include yttrium (Y). That is, the halide solid electrolyte may contain Y as a metal element. According to this feature, the ion conductivity of the second solid electrolyte material can be further improved. As a result, the output properties of the battery 20 can be further improved.

The Y-containing halide solid electrolyte may be a compound represented by formula LiₐMe_{b}Y_{c}X2₆, for example. Here, a+mb+3c=6, and c>0 are satisfied. Me is at least one element selected from the group consisting of metalloids and metal elements other than Li and Y. m represents the valency of Me. X2 includes I and at least one element selected from the group consisting of F, Cl, and Br. According to these features, the ion conductivity of the second solid electrolyte material can be further improved. As a result, the output properties of the battery 20 can be further improved.

Me may be at least one element selected from the group consisting of Mg, Ca, Sr, Ba, Zn, Sc, Al, Ga, Bi, Zr, Hf, Ti, Sn, Ta, and Nb, for example. According to this feature, the ion conductivity of the second solid electrolyte material can be further improved. As a result, the output properties of the battery 20 can be further improved.

Examples of the halide solid electrolyte contained in the second solid electrolyte material are the following materials. According to the feature below, the ion conductivity of the second solid electrolyte material can be further improved. As a result, the output properties of the battery 20 can be further improved.

The halide solid electrolyte may be a material represented by Formula (B1) below.

Li_{6-3d}Y_{d}X2₆ (B1)

In Formula (B1), X2 includes I and at least one element selected from the group consisting of F, Cl, and Br.

In Formula (B1), 0<d<2 is satisfied.

The halide solid electrolyte may be a material represented by Formula (B2) below.

Li₃YX2₆ (B2)

In Formula (B2), X2 includes I and at least one element selected from the group consisting of F, Cl, and Br.

The halide solid electrolyte may be a material represented by Formula (B3) below.

Li_{3-3δ+a}Y_{1+δ-a}MeₐCl_{6-x-y}BrₓI_{y} (B3)

In Formula (B3), Me is at least one element selected from the group consisting of Mg, Ca, Sr, Ba, and Zn.

In Formula (B3), −1<δ<2, 0<a<3, 0<(3−3δ+a), 0<(1+δ−a), 0≤x≤6, 0<y≤6, and (x+y)<6 are satisfied.

The halide solid electrolyte may be a material represented by Formula (B4) below.

Li_{3-3δ}Y_{1+δ-a}MeₐCl_{6-x-y}BrₓI_{y} (B4)

In Formula (B4), Me is at least one element selected from the group consisting of Al, Sc, Ga, and Bi.

In Formula (B4), −1<δ<1, 0<a<2, 0<(1+δ−a), 0≤x<6, 0<y≤6, and (x+y)<6 are satisfied.

The halide solid electrolyte may be a material represented by Formula (B5) below.

Li_{3-3δ-a}Y_{1+δ-a}MeₐCl_{6-x-y}BrₓI_{y} (B5)

In Formula (B5), Me is at least one element selected from the group consisting of Zr, Hf, and Ti.

In Formula (B5), −1<δ<1, 0<a<1.5, 0<(3−3δ−a), 0<(1+δ−a), 0≤x<6, 0<y≤6, and (x+y)<6 are satisfied.

The halide solid electrolyte may be a material represented by Formula (B6) below.

Li_{3-3δ-2a}Y_{1+δ-a}MeₐCl_{6-x-y}BrₓI_{y} (B6)

In Formula (B6), Me is at least one element selected from the group consisting of Ta and Nb.

In Formula (B6), −1<δ<1, 0<a<1.2, 0<(3−3δ−2a), 0<(1+δ−a), 0≤x<6, 0<y≤6, and (x+y)<6 are satisfied.

Specific examples of the halide solid electrolyte that can be used include Li₃YX2₆, Li₂MgX2₄, Li₂FeX2₄, Li(Al,Ga,In)X2₄, and Li₃(Al,Ga,In)X2₆. Here, X2 contains I and at least one element selected from the group consisting of F, Cl, and Br.

The average thickness of the first electrolyte layer 101 and the average thickness of the second electrolyte layer 102 may each be greater than or equal to 1 μm and less than or equal to 300 μm. When the average thickness of the first electrolyte layer 101 and the average thickness of the second electrolyte layer 102 are each greater than or equal to 1 μm, short circuiting between the positive electrode 201 and the negative electrode 202 rarely occurs. When the average thickness of the first electrolyte layer 101 and the average thickness of the second electrolyte layer 102 are each less than or equal to 300 μm, the battery 20 can operate at high output. The average thickness of the first electrolyte layer 101 and the average thickness of the second electrolyte layer 102 may be equal to each other or different from each other.

The method for measuring the average thicknesses of the first electrolyte layer 101 and the second electrolyte layer 102 can be the method described in the first embodiment regarding the average thickness of the electrolyte layer 100.

The first electrolyte layer 101 may contain 100 mass % of a halide solid electrolyte in terms of the mass ratio relative to the entirety of the first electrolyte layer 101 excluding the unavoidable impurities. In other words, the first electrolyte layer 101 may consist essentially of a halide solid electrolyte. The second electrolyte layer 102 may contain 100 mass % of a halide solid electrolyte in terms of the mass ratio relative to the entirety of the second electrolyte layer 102 excluding the unavoidable impurities. In other words, the second electrolyte layer 102 may consist essentially of a halide solid electrolyte.

The first electrolyte layer 101 may contain a halide solid electrolyte as a main component and, additionally, may contain unavoidable impurities or starting materials used for the synthesis of the halide solid electrolyte, by-products, and decomposition products. The second electrolyte layer 102 may contain a halide solid electrolyte as a main component and, additionally, may contain unavoidable impurities or starting materials used for the synthesis of the halide solid electrolyte, by-products, and decomposition products. The ratio of the mass of the halide solid electrolyte relative to the mass of the first electrolyte layer 101 may be, for example, greater than or equal to 50 mass % or greater than or equal to 70 mass %. The ratio of the mass of the halide solid electrolyte relative to the mass of the second electrolyte layer 102 may be, for example, greater than or equal to 50 mass % or greater than or equal to 70 mass %.

At least one selected from the group consisting of the first electrolyte layer 101 and the second electrolyte layer 102 may contain at least one electrolyte selected from the group consisting of sulfide solid electrolytes, oxide solid electrolytes, polymeric solid electrolytes, and complex hydride solid electrolytes. Examples of the sulfide solid electrolytes, the oxide solid electrolytes, the polymeric solid electrolytes, and the complex hydride solid electrolytes are the same as those materials described as examples of the solid electrolyte contained in the positive electrode 201. According to this feature, lithium ion exchange is facilitated. As a result, the output properties of the battery 20 can be further improved.

At least one selected from the group consisting of the positive electrode 201, the first electrolyte layer 101, the second electrolyte layer 102, and the negative electrode 202 may contain a nonaqueous electrolyte solution, a gel electrolyte, or an ionic liquid. According to this feature, lithium ion exchange is facilitated. As a result, the output properties of the battery 10 can be further improved. The nonaqueous electrolyte solution, the gel electrolyte, and the ionic liquid can be those described as examples in the second embodiment.

At least one selected from the group consisting of the positive electrode 201, the first electrolyte layer 101, the second electrolyte layer 102, and the negative electrode 202 may contain a binder to improve adhesion between particles. The binder can be those described as examples in the second embodiment.

Examples of the shape of the battery 20 include a coin shape, a cylinder shape, a prism shape, a sheet shape, a button shape, a flat shape, and a multilayer shape.

The battery 20 that includes the positive electrode 201, the first electrolyte layer 101, the second electrolyte layer 102, and the negative electrode 202 may be stacked in multiple layers with current collectors therebetween. Connecting more than one batteries electrically in series can increase the voltage of the battery. Connecting more than one batteries electrically in parallel can increase the capacity of the battery. Connecting more than one batteries electrically in series and in parallel can increase the voltage and the capacity of the battery 20.

### Method for Producing First Solid Electrolyte Material

In this embodiment, the method described in relation to the halide solid electrolyte of the first embodiment can be applied as the method for producing a halide solid electrolyte represented by Formula (1) serving as a first solid electrolyte material.

### Method for Producing Second Solid Electrolyte Material

In this embodiment, a halide solid electrolyte represented by Formula (2) serving as the second solid electrolyte material can be produced by, for example, the following method.

First, in accordance with the target composition, multiple types of raw material powders of a ternary halide are prepared. A ternary halide refers to a compound constituted by three elements including a halogen. For example, when Li₃YBr₂Cl₂I₂ is to be prepared, the raw material powders LiBr, LiCl, LiI, YCl₃, and YBr₃ are prepared at a molar ratio of 1:1:4:1:1. Here, the elements represented by “M2” and “X2” in Formula (2) are determined by selecting the type of the raw material powder. Moreover, the values represented by “α2”, “δ2”, and “γ2” in Formula (2) are determined by adjusting the type of the raw material powder, the blend ratio of the raw material powders, and the synthetic process.

After the raw material powders are mixed and crushed, the raw material powders are reacted with one another by mechanochemical milling. Alternatively, after mixing and crushing the raw material powders, the resulting mixture may be sintered in vacuum or in an inert atmosphere. For example, heat treatment may be performed in the temperature range of 100° C. to 400° C. for 1 hour or longer. A halide solid electrolyte represented by Formula (2) is obtained by such methods.

### Method for Producing Battery

A battery that uses the first solid electrolyte material and the second solid electrolyte material produced as described above can be produced by, for example, a method (dry method) described in the second embodiment with reference to FIG. 2.

In this embodiment, a powder of the second solid electrolyte material is placed in the insulating tube 3 and pressed to form a second electrolyte layer 102, and then a powder of the first solid electrolyte material is placed and pressed to form a first electrolyte layer 101 on the second electrolyte layer 102.

### EXAMPLES

In the description below, the details of the present disclosure are disclosed through Examples relevant to the first and second embodiments and Comparative Examples.

### Preparation of Solid Electrolyte Material

In a glove box having an argon atmosphere with a dew point lower than or equal to −60° C., raw material powders, LiBr, YBr₃, LiCl, and YCl₃ were weighed such that the molar ratio was LiBr:YBr₃:LiCl:YCl₃=1:1:5:1. These raw material powders were mixed in an agate mortar to obtain a mixture. Next, a planetary ball mill (model P-7 produced by Fritsch Japan Co., Ltd.) was used to mill the obtained mixture for 25 hours under the condition of 600 rpm. As a result, a powder of a synthetic product represented by formula Li₃YBr₂Cl₄ was obtained.

### Powder Compact

### Example 1

In a glove box having an argon atmosphere with a dew point lower than or equal to −60° C., Li₃YBr₂Cl₄ prepared by the aforementioned method and Al₂O₃ were weighed such that the volume ratio was Li₃YBr₂Cl₄:Al₂O₃=30:70. These raw material powders were mixed in an agate mortar. The resulting mixture (150 mg) was press-formed at a temperature of 120° C. and a pressure of 720 MPa for 30 minutes to obtain a powder compact of Example 1. Al₂O₃ was added as a substitute for a hard oxide such as a positive electrode active material. In this manner, the environment in an actual electrode can be simulated.

### Example 2

A powder compact of Example 2 was obtained as with the powder compact of Example 1 except that the press-forming was performed at a temperature of 220° C.

### Comparative Example 1

A powder compact of Comparative Example 1 was obtained as with the powder compact of Example 1 except that heating was not performed during press-forming. That is, in Comparative Example 1, press-forming was performed at room temperature (RT).

### Calculation of Crystallite Size

The crystallite size of Li₃YBr₂Cl₄ was calculated by using the powder compacts of Example 1 and Comparative Example 1. The crystallite size was measured from the intensity of the X-ray diffraction peak of a powder compact measured with a powder X-ray diffractometer (MiniFlex600 produced by Rigaku Corporation) through Equations (I) and (II) described above. Specifically, the crystallite size was measured on the basis of the full width at half maximum (FWHM) of the X-ray diffraction peak (2θ=approximately 28.4°) derived from the (111) plane of standard sample Si through Equations (I) and (II) described above. The measurement conditions of the X-ray diffraction peak are as follows.
X-ray source: CuKα radiation (wavelength: 0.15406 nm)
Measurement range: 2θ=100 to 800
Sampling step width: 0.01°
Scanning rate: 10°/minute

FIG. 4 is a graph indicating powder X-ray diffraction patterns of powder compacts of Example 1 and Comparative Example 1. In FIG. 4, the vertical axis indicates the number of diffracted X-rays captured by the powder X-ray diffractometer per second, in other words, the diffracted X-ray intensity. The horizontal axis indicates the diffraction angle (20).

From the obtained powder X-ray diffraction pattern, a diffraction peak was designated as described below, and separated according to the following description.

### Designation of Diffraction Peak

X-ray diffraction peak derived from (002) plane of Li₃YBr₂Cl₄: 28.6°

### Separation of Diffraction Peak

Profile shape function: Pseudo-Voigt

The crystallite size of Li₃YBr₂Cl₄ in the powder compacts of Example 1 and Comparative Example 1 was calculated under the aforementioned conditions. The results are indicated in Table 1 below.

TABLE 1

| | Example 1 | Comparative Example 1 |
|---|---|---|
| Crystallize size (nm) | 45.80303 | 31.822129 |

### Evaluation of Crystallinity

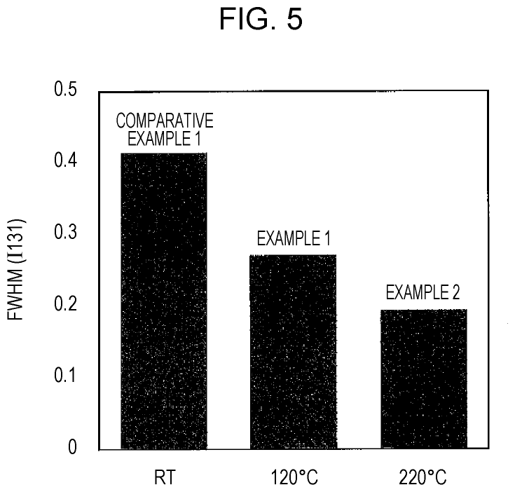

The crystallinity was evaluated by using the powder compacts of Examples 1 and 2 and Comparative Example 1. The full width at half maximum (FWHM) of the X-ray diffraction peak was also measured for Example 2 by the same method as with Example 1 and Comparative Example 1. The smaller the FWHM, the higher the crystallinity. FWHM in Examples 1 and 2 and Comparative Example 1 were, respectively, 0.270, 0.194, and 0.414. The results are indicated in FIG. 5.

FIG. 5 is a graph indicating the crystallinity of the powder compacts of Examples 1 and 2 and Comparative Example 1. In FIG. 5, the vertical axis indicates the X-ray diffraction peak full width at half maximum (FWHM). The horizontal axis indicates the temperature.

### Example 3

### Positive Electrode Material

As the positive electrode active material, Li(Ni,Co,Mn)O₂ (hereinafter, referred to as NCM) was used. As the solid electrolyte, Li₃YBr₂Cl₄ prepared by the aforementioned method was used. In a glove box having an argon atmosphere with a dew point lower than or equal to −60° C., Li₃YBr₂Cl₄ and NCM were weighed such that the volume ratio was Li₃YBr₂Cl₄:NCM=30:70. These raw material powders were mixed in an agate mortar to obtain a positive electrode material.

### Negative Electrode Material

As the negative electrode active material, Li₄Ti₅O₁₂ (hereinafter, referred to as LTO) was used. As the solid electrolyte, Li₃YBr₂Cl₄ prepared by the aforementioned method was used. In a glove box having an argon atmosphere with a dew point lower than or equal to −60° C., Li₃YBr₂Cl₄ and LTO were weighed such that the volume ratio was Li₃YBr₂Cl₄:LTO=40:60. These raw material powders were mixed in an agate mortar to obtain a negative electrode material.

### Preparation of Secondary Battery

The powder of Li₃YBr₂Cl₄, the positive electrode material, and the negative electrode material described above were used to perform following steps.

First, a lower die 1 was inserted into an insulating tube 3 such as the one illustrated in FIG. 2. Into the insulating tube 3, 120 mg of the powder of Li₃YBr₂Cl₄ and 19.3 mg of the positive electrode material were injected in this order. The upper die 2 was inserted into the insulating tube 3, and press-forming was performed at a pressure of 360 MPa to form a positive electrode 201 on an electrolyte layer 100 made of Li₃YBr₂Cl₄.

After formation of the positive electrode 201, the lower die 1 was removed, and 32.1 mg of the negative electrode material was injected. The lower die 1 was inserted again, and press-forming was performed at a pressure of 720 MPa to form a negative electrode 202. As a result, a power generating element 9 was formed.

The power generating element 9 was press-formed at a temperature of 120° C. at a pressure of 720 MPa for 30 minutes to prepare a multilayer body constituted by the positive electrode 201, the electrolyte layer 100, and the negative electrode 202.

Next, stainless steel current collectors were placed at the bottom and on the top of the multilayer body, and current collecting leads were attached to the current collectors.

Lastly, the inside of the insulating tube 3 was shut-out from the outside atmosphere and sealed by using an insulating ferrule so as to produce a battery 10 of Example 3.

### Comparative Example 2

### Preparation of Secondary Battery

A battery of Comparative Example 2 was prepared as with the battery of Example 3 except that, after formation of the power generating element 9, the press-forming was not conducted at a temperature of 120° C. and a pressure of 720 MPa.

### Charge-Discharge Test

A charge-discharge test was performed under the following conditions on the batteries of Example 3 and Comparative Example 2.

The battery was placed in a 25° C. constant-temperature oven.

The battery was charged at a current value equivalent to a 2C rate (0.5 hour rate) with respect to the theoretical capacity of the battery, and the charging was terminated at a voltage of 2.75 V.

Next, the battery was discharged at a current value equivalent to a 2C rate, and the discharging was terminated at a voltage of 1.95 V.

The results of the charge-discharge test are indicated in Table 2 below.

TABLE 2

| | Example 3 | Comparative Example 2 |
|---|---|---|
| Discharge capacity (mAh/g) | 90.6 | 67.8 |

### Observations

The powder compact of Comparative Example 1 was obtained without heating during the pressing. The powder compact of Example 1 was obtained by pressing while heating. By pressing while heating, the crystallite size of the halide solid electrolyte increased. In the powder compact of Example 1, the crystallite size of the halide solid electrolyte exceeded 45 nm.

As illustrated in FIG. 5, crystallinity of Examples 1 and 2, in which the heating temperature during pressing was higher than or equal to 100° C., improved compared to Comparative Example 1. Comparison of Example 1 and Example 2 reveals that the crystallinity improved with the increase in temperature during pressing.

The battery of Comparative Example 2 was obtained without heating during the pressing. The pressing conditions of the battery of Comparative Example 2 were coincident with the pressing conditions of the powder compact of Comparative Example 1. Thus, the state of the solid electrolyte material in the battery of Comparative Example 2 can be considered to be coincident with the state of the solid electrolyte material in the powder compact of Comparative Example 1. The battery of Example 3 was obtained by pressing while heating. The pressing conditions of the battery of Example 3 were coincident with the pressing conditions of the powder compact of Example 1. Thus, the state of the solid electrolyte material in the battery of Example 3 can be considered to be coincident with the state of the solid electrolyte material in the powder compact of Example 1.

As indicated in Table 2, the discharge capacity of the battery of Example 3 exceeded the discharge capacity of the battery of Comparative Example 2. The discharge capacity increased 22.8 mAh/g. In other words, as the crystallinity of the halide solid electrolyte improves through the step of pressing while heating, the output properties of the battery also improved prominently.

The battery of the present disclosure can be used as, for example, an all-solid lithium ion secondary battery.

What is claimed is:

1. A solid electrolyte material comprising:
a halide solid electrolyte,
wherein the halide solid electrolyte contains Li, at least one element selected from the group consisting of metalloids and metal elements other than Li, and at least one element selected from the group consisting of F, Cl, Br, and I, and
the halide solid electrolyte has a crystallite size greater than or equal to 40 nm.

2. The solid electrolyte material according to claim 1,
wherein the halide solid electrolyte is free of sulfur.

3. The solid electrolyte material according to claim 1,
wherein the halide solid electrolyte is represented by Formula (1) below:
Li_{α1}M1_{β1}X1_{γ1} (1)
where α1, β1, and γ1 are each a value greater than 0,
M1 is at least one element selected from the group consisting of metalloids and metal elements other than Li, and
X1 is at least one element selected from the group consisting of F, Cl, Br, and I.

4. The solid electrolyte material according to claim 3,
wherein, in Formula (1), 2≤γ1/α1≤2.4 is satisfied.

5. The solid electrolyte material according to claim 3,
wherein, in Formula (1),
2.5≤α1≤3,
1≤β1≤1.1, and
γ1=6
are satisfied.

6. The solid electrolyte material according to claim 3,
wherein, in Formula (1), M1 includes yttrium.

7. A battery comprising:
a positive electrode, an electrolyte layer, and a negative electrode arranged in this order,
wherein at least one selected from the group consisting of the positive electrode, the electrolyte layer, and the negative electrode contains the solid electrolyte material according to claim 1.

8. The battery according to claim 7,
wherein the positive electrode contains a positive electrode active material, and
the positive electrode active material contains lithium nickel cobalt manganese oxide.
